(19) United States
(12) Patent Application Publication
(10) Pub. No.: US 2013/0002936 A1
(43) Pub. Date: Jan. 3, 2013

(54) IMAGE PICKUP APPARATUS, IMAGE PROCESSING APPARATUS, AND STORAGE MEDIUM STORING IMAGE PROCESSING PROGRAM

(75) Inventors: Nobutaka HIRAMA, Saitama-shi (JP); Akihiko TAKAHASHI, Kawasaki-shi (JP)

(73) Assignee: NIKON CORPORATION, Tokyo (JP)

(21) Appl. No.: 13/532,236

(22) Filed: Jun. 25, 2012

Related U.S. Application Data
(60) Provisional application No. 61/592,105, filed on Jan. 30, 2012.

(30) Foreign Application Priority Data
Jun. 30, 2011 (JP) 2011-145704

(51) Int. Cl. H04N 5/232

(52) U.S. Cl. 348/349; 348/E05.024

(57) ABSTRACT

An image pickup apparatus is characterized in that it includes an imaging element having imaging pixels and focus detecting pixels, a determining unit determining an amount of noise superimposed on an image obtained by driving the imaging element, and a pixel interpolation unit executing the interpolation processing from among a plurality of interpolation processings with different processing contents in accordance with a determination result of the amount of noise determined by the determining unit, with respect to the image, to generate interpolation pixel values with respect to the focus detecting pixels.

### CROSS REFERENCE TO RELATED APPLICATION

This application is based upon and claims the benefit of priority from Japanese Patent Application No. 2011-145704, filed on Jun. 30, 2011 and U.S. Provisional Patent Application No. 61/592,105, filed on Jan. 30, 2012, the entire contents of which are incorporated herein by reference.

### BACKGROUND

1. Field

The present application relates to an image pickup apparatus, an image processing apparatus, and a storage medium storing an image processing program.

2. Description of the Related Art

Conventionally, an imaging element in which a plurality of pixels for focus detection are arranged on a part of a light-receiving surface on which a plurality of imaging pixels are two-dimensionally arranged, has been known (refer to Japanese Unexamined Patent Application Publication No. 2009-303194). The plurality of imaging pixels have spectral characteristics corresponding to respective plural color components, and further, the pixels for focus detection (focus detecting pixels) have spectral characteristics which are different from the spectral characteristics of the plurality of imaging pixels. From the plurality of imaging pixels, signals for generating an image are read to determine pixel values of the imaging pixels, and further, from the focus detecting pixels, signals for focus detection are read to determine pixel values of the focus detecting pixels. When performing pixel interpolation, a pixel value of a missing color component out of pixel values of the imaging pixels is interpolated, and an imaging pixel value corresponding to a position of the focus detecting pixel is interpolated.

In the invention described in Japanese Unexamined Patent Application Publication No. 2009-303194, in order to perform interpolation processing with respect to a focus detecting pixel, an interpolation pixel value of the focus detecting pixel is generated by using pixel values of imaging pixels positioned in a neighborhood of the focus detecting pixel, an evaluation pixel value being a pixel value when the neighboring imaging pixel has the same spectral characteristics as those of the focus detecting pixel is calculated, a high frequency component of image is calculated by using a pixel value of the focus detecting pixel and the evaluation pixel value, and the high frequency component is added to the interpolation pixel value to calculate a pixel value of imaging pixel corresponding to a position of the focus detecting pixel.

However, when a photographing state in which a large amount of noise is generated is provided, pixel values of imaging pixels in a neighborhood of a focus detecting pixel vary greatly. When calculating a pixel value of imaging pixel corresponding to a position of the focus detecting pixel by using the pixel values of imaging pixels which are varied as described above, interpolation which is beyond assumption is sometimes performed, resulting in that a pixel with false color is generated in an image. For example, when focus detecting pixels provided on an imaging element are arranged along a horizontal line, and if a false color is generated in each of the respective focus detecting pixels, an area of pixels with false colors becomes conspicuous along a horizontal direction of the image, resulting in that the image becomes one that gives a sense of strangeness to eyes of a user.

### SUMMARY

The present invention has been made in view of the above-described points, and a proposition thereof is to provide an image pickup apparatus, an image processing apparatus, and a storage medium storing an image processing program capable of performing pixel interpolation in which a false color is not generated in an image even in a case where a large amount of noise is generated.

An aspect of an image pickup apparatus includes an imaging element having imaging pixels and focus detecting pixels, a determining unit determining an amount of noise superimposed on an image obtained by driving the imaging element, and a pixel interpolation unit executing the interpolation processing from among a plurality of interpolation processings with different processing contents in accordance with a determination result of the amount of noise determined by the determining unit, with respect to the image, to generate interpolation pixel values with respect to the focus detecting pixels.

Further, the determining unit determines the amount of noise superimposed on the image by using a photographic sensitivity at a time of performing photographing and a charge storage time in the imaging element.

Further, there is provided a temperature detection unit detecting a temperature of one of the imaging element and a control board provided in the image pickup apparatus, and the determining unit determines the amount of noise superimposed on the image by using the temperature of one of the imaging element and the control board, in addition to the photographic sensitivity at the time of performing photographing and the charge storage time in the imaging element.

Further, the pixel interpolation unit executes the interpolation processing using pixel values of the imaging pixels positioned in a neighborhood of the focus detecting pixels, to generate the interpolation pixel values with respect to the focus detecting pixels when the determining unit determines that the amount of noise superimposed on the image is large.

Further, the pixel interpolation unit executes the interpolation processing using pixel values of the focus detecting pixels and the imaging pixels positioned in the neighborhood of the focus detecting pixels, to generate the interpolation pixel values with respect to the focus detecting pixels when the determining unit determines that the amount of noise superimposed on the image is small.

Further, there is provided a shutter moving between an open position in which a subject light is irradiated to the imaging element and a light-shielding position in which the subject light is shielded, the image is formed of a first image obtained when the shutter is held at the open position by the charge storage time, and a second image obtained when the shutter is held at the light-shielding position by the charge storage time, and the image interpolation unit executes the interpolation processing based on an estimation result of the amount of noise with respect to the first image and the second image.

In this case, it is preferable that there is further provided an image processing unit subtracting each pixel value of the second image from each pixel value of the first image after performing the interpolation processing on the images by the pixel interpolation unit.

Further, an image processing apparatus includes an image capturing unit capturing an image obtained by using an imaging element having imaging pixels and focus detecting pixels, a determining unit determining an amount of noise superimposed on the image, and a pixel interpolation unit executing the interpolation processing from among a plurality of interpolation processings with different processing contents in accordance with a determination result of the amount of noise determined by the determining unit, with respect to the image, to generate interpolation pixel values with respect to the focus detecting pixels.

Further, a non-transitory computer readable storage medium storing an image processing program causing a computer to execute an image capturing process of capturing an image obtained by using an imaging element having imaging pixels and focus detecting pixels, a determining process of determining an amount of noise superimposed on the image, and a pixel interpolation process of executing the interpolation processing from among a plurality of interpolation processings with different processing contents in accordance with a determination result of the amount of noise determined by the determining process, with respect to the image, to generate interpolation pixel values with respect to the focus detecting pixels.

### BRIEF DESCRIPTION OF THE DRAWINGS

FIG. 1 is a functional block diagram illustrating an electrical configuration of an electronic camera.

FIG. 2 is a diagram illustrating an example of arrangement of imaging pixels and AF pixels.

FIG. 3 is a diagram illustrating a part of image data in which an area in which the AF pixels are arranged is set as a center.

FIG. 4 is a diagram illustrating an AF pixel interpolation unit provided with a noise determination unit and a flare determination unit.

FIG. 5 is a flow chart explaining an operation of the AF pixel interpolation unit.

FIG. 6 is a flow chart illustrating a flow of second pixel interpolation processing.

FIG. 7 is a diagram representing an example of image structure in which an effect of the present embodiment is exerted.

FIG. 8 is a flow chart illustrating a flow of third pixel interpolation processing.

FIG. 9 is a flow chart explaining an operation of the AF pixel interpolation unit.

### DETAILED DESCRIPTION OF THE EMBODIMENT

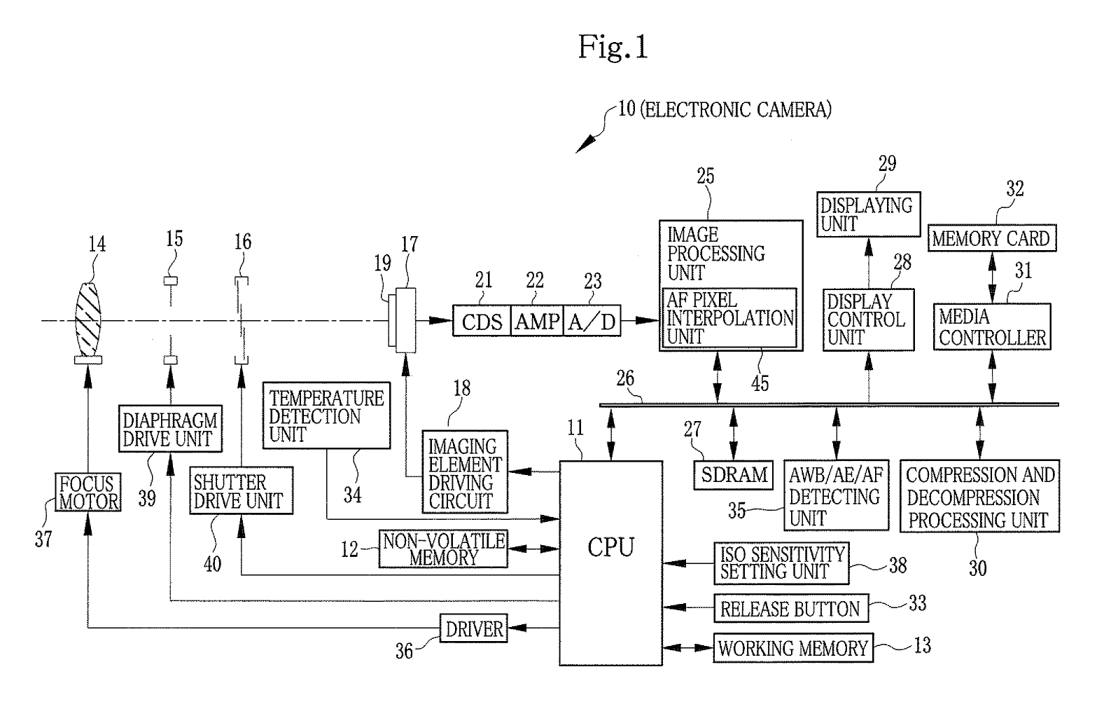

As illustrated in FIG. 1, an electronic camera 10 to which the present invention is applied includes a CPU 11. To the CPU 11, a non-volatile memory 12, and a working memory 13 are connected, and the non-volatile memory 12 stores a control program which is referred to when the CPU 11 performs various controls, and so on. In addition, the non-volatile memory 12 stores data indicating position coordinates of AF pixels of an imaging element 17, previously determined data of various threshold values, weighted coefficients and so on used for an image processing program, various determination tables and the like, which will be described later in detail.

The CPU 11 performs, in accordance with a control program stored in the non-volatile memory 12, control of respective units by utilizing the working memory 13 as a temporary storage working area, to thereby activate respective units (circuits) that form the electronic camera 10.

A subject light incident from a photographic lens 14 is image-formed on a light-receiving surface of the imaging element 17 such as a CCD and a CMOS via a diaphragm 15 and a shutter 16. An imaging element driving circuit 18 drives the imaging element 17 based on a control signal from the CPU 11. The imaging element 17 is a Bayer pattern type single-plate imaging element, and to a front surface thereof, primary color transmission filters 19 are attached.

The primary color transmission filters 19 are arranged in a primary color Bayer pattern in which, with respect to a total number of pixels N of the imaging element 17, a resolution of G (green) becomes N/2, and a resolution of each of R (red) and B (blue) becomes N/4, for example.

A subject image formed on the light-receiving surface of the imaging element 17 is converted into an analog image signal. The image signal is output to a CDS 21 and an AMP 22, in this order, that form an AFE (Analog Front End) circuit, in which the signal is subjected to predetermined analog processing in the AFE circuit, and then the resultant is converted into digital image data in an A/D (Analog/Digital converter) 23 to be transmitted to an image processing unit 25.

The image processing unit 25 includes a separation circuit, a white balance processing circuit, a pixel interpolation (demosaicing) circuit, a matrixing circuit, a nonlinear conversion (γ correction) processing circuit, an edge enhancement processing circuit and the like, and performs white balance processing, pixel interpolation processing, matrixing, nonlinear conversion (γ correction) processing, edge enhancement processing and the like on the digital image data. The separation circuit separates a signal output from an imaging pixel and a signal output from a focus detecting pixel, which will be described later in detail. The pixel interpolation circuit converts a Bayer pattern signal in which one pixel is formed of one color into a normal color image signal in which one pixel is formed of three colors.

The image data with three colors output from the image processing unit 25 is stored in an SDRAM 27 via a bus 26. The image data stored in the SDRAM 27 is read through a control of the CPU 11 to be transmitted to a display control unit 28. The display control unit 28 converts the input image data into a signal in a predetermined format for display (a color complex video signal in an NTSC format, for example), and outputs the resultant to a displaying unit 29 as a through image.

Further, image data obtained in response to a shutter release is read from the SDRAM 27 and then transmitted to a compression and decompression processing unit 30 in which compression processing is performed, and the resultant is recorded in a memory card 32 being a recording medium via a media controller 31.

To the CPU 11, a release button 33 and a power switch (not illustrated) are connected, and temperature information is input from a temperature detection unit 34 that detects a temperature of the imaging element 17. The information is transmitted to the image processing unit 25, and is utilized when determining a noise, which will be described later in detail.

An AWB/AE/AF detecting unit 35 detects, based on a signal of focus detecting pixel (AF pixel), a defocus amount, and a direction of defocus using a pupil division type phase difference detection method. The CPU 11 controls a driver 36 based on the defocus amount, and the direction of defocus obtained by the AWB/AE/AF detecting unit 35 to drive a focus motor 37, thereby making a focus lens move forward/backward in an optical axis direction to perform focusing.

Further, the AWB/AE/AF detecting unit 35 calculates, from a photometric brightness value (BY) calculated based on a signal of imaging pixel, and an ISO sensitivity value (Sv) set by a person who performs photographing in an ISO sensitivity setting unit 38, a light value (Lv=Sv+By). Further, the AWB/AE/AF detecting unit 35 decides a diaphragm value and a shutter speed so that an exposure value (Ev=Av+Tv) becomes the determined light value Lv. Based on the decision, the CPU 11 drives a diaphragm drive unit 39 to adjust a diaphragm diameter of the diaphragm 15 so that the diaphragm has the determined diaphragm value. In conjunction with that, the CPU 11 drives a shutter drive unit 40 to execute an opening/closing operation of the shutter 16 so that the shutter 16 is opened at the determined shutter speed.

The AWB/AE/AF detecting unit 35 performs a thinning-out reading from the image data of one screen captured in the SDRAM 27, at the time of performing auto white balance adjustment, and generates AWB evaluation data of 24×16, for example. Further, the AWB/AE/AF detecting unit 35 performs light source type determination using the generated AWB evaluation data, and performs correction on a signal of each color channel in accordance with a white balance adjustment value suitable for the determined light source type.

As the imaging element 17, a semiconductor image sensor of CCD or CMOS in which the primary color transmission filter 19 of any one of R (red), G (green), and B (blue) is arranged, in a Bayer pattern, on each of a plurality of imaging pixels which are provided on a light-receiving surface of the semiconductor image sensor, and a microlens array is provided on the filter, or the like is appropriately selected to be used. Further, the imaging element 17 of the present embodiment has a plurality of AF pixels 41 one-dimensionally arranged in a horizontal scanning direction, on a part of area on the light-receiving surface. On those AF pixels 41, the primary color transmission filters 19 are not disposed. Further, there are two types of AF pixels 41, which are, one that receives light of luminous flux that passes through a left side of a pupil of an optical system of the photographic lens 14, and one that receives light of luminous flux that passes through a right side of the pupil of the optical system of the photographic lens 14. The imaging element 17 can individually read pixel signals from the imaging pixel group, and the AF pixel group.

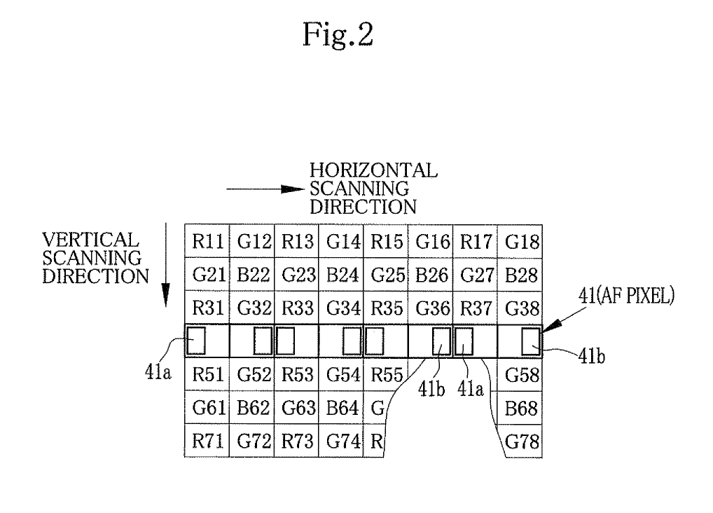

As illustrated in FIG. 2, the AF pixels 41 have sensor openings 41a, 41b each deviated to one side with respect to a cell center (center of microlens), and are one-dimensionally arranged along a direction of the deviation. The sensor openings 41a, 41b have a mutually opposite direction of deviation, and a distance of the deviation is the same. The AF pixel 41 having the sensor opening 41a is disposed instead of a G pixel in an RGB primary color Bayer pattern, and further, the AF pixel 41 having the sensor opening 41b is disposed instead of a B pixel in the RGB primary color Bayer pattern. A pupil division phase difference AF method is realized by the AF pixels 41 having such sensor openings 41a, 41b. Specifically, if lights of two partial luminous fluxes existed at positions symmetric with respect to an optical axis of the photographic lens 14, among luminous fluxes passing through an exit pupil, are respectively received by the AF pixel 41 having the sensor opening 41a and the AF pixel 41 having the sensor opening 41b, a direction of focus deviation (moving direction of focusing lens), and an amount of focus deviation (movement amount of focusing lens) can be determined from a phase difference of signals output from the two pixels 41. This enables to perform speedy focusing.

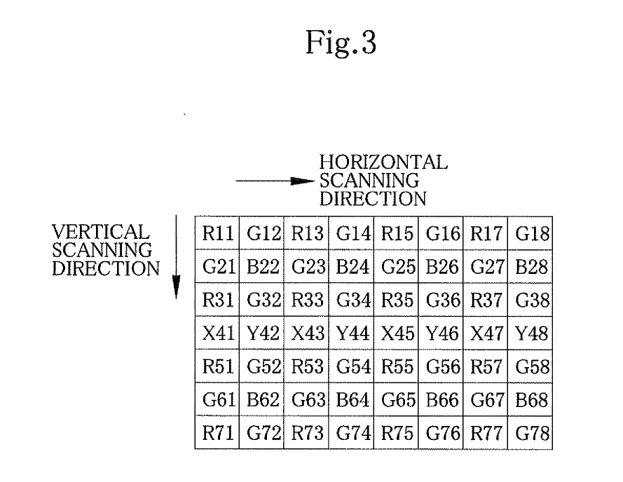

Therefore, each of the AF pixels 41 in the present embodiment outputs a pupil-divided detection signal of the left side or the right side in accordance with a brightness of white light. FIG. 3 illustrates a part of image data in which an area in which the AF pixels 41 are arranged is set as a center, out of the image data imaged by the imaging element 17. Each cell represents one pixel. Symbols R, G and B at the head of respective cells indicate the imaging pixels having respective primary color transmission filters 19. Meanwhile, each of symbols X and Y indicates the AF pixel having sensitivity to the luminous flux from the left side or the right side, and those AF pixels are alternately arranged one-dimensionally in the horizontal scanning direction. A two-digit number subsequent to each of these symbols indicates a pixel position.

The pixel interpolation unit includes an AF pixel interpolation unit 45 interpolating pixel values of the AF pixels 41 by using pixel values of the imaging pixels, and a pixel interpolation unit performing color interpolation based on a linear interpolation method from the Bayer pattern into RGB after interpolating the pixel values of the AF pixels.

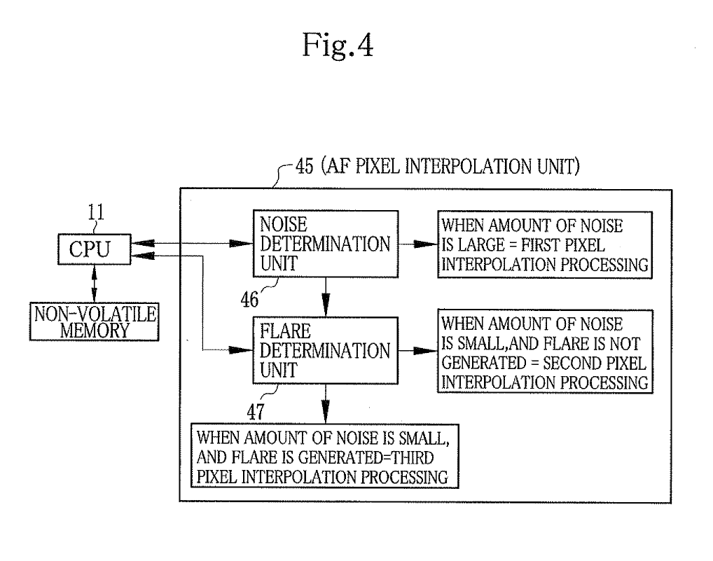

As illustrated in FIG. 4, the AF pixel interpolation unit 45 includes a noise determination unit 46, and a flare determination unit 47, and performs different AF pixel interpolation processings based on a determination given by these determination units. The noise determination unit 46 determines whether there is provided a condition in which a large amount of noise is generated, based on photographing conditions at the time of performing photographing. The photographing conditions include a temperature of the imaging element 17, an ISO sensitivity, a shutter speed and the like. Temperature information of the imaging element 17 is obtained from the CPU 11. Further, information regarding the ISO sensitivity and the shutter speed set at the time of performing photographing, is also obtained from the CPU 11 together with the temperature information.

The noise determination unit 46 determines whether the amount of noise is large or small, based on the information regarding the temperature of the imaging element 17, the ISO sensitivity, and the shutter speed. Note that it is also possible to design such that a temperature detection unit is provided on a main board on which the imaging element 17 is mounted, and a temperature of the main board, or a temperature surrounding the imaging element 17 is used instead of the temperature of the imaging element 17. Besides, the information used for the noise determination is not limited to the three pieces of information regarding the temperature of the imaging element 17, the ISO sensitivity and the shutter speed, and the information may be any one of or two pieces of the three pieces of information described above.

When the noise determination unit 46 determines that the amount of noise is large, a pixel value of the AF pixel is not used, and first pixel interpolation processing in which, for example, simple average interpolation is performed by using pixel values of imaging pixels in the neighborhood of the AF pixel, is conducted. When it is determined that the amount of noise is small, the flare determination is performed in the flare determination unit 47, and in accordance with whether or not the flare is generated, second or third pixel interpolation processing different from the first pixel interpolation processing is conducted.

The flare determination unit 47 extracts an area with high brightness (high brightness area) based on a brightness histogram of the image data, and then determines whether a magenta color, for example, exists in the extracted high brightness area, in which, when the magenta color exists, an edge amount and a variance value of brightness component in an area with the magenta color (magenta area) are calculated, a threshold determination is performed on each of “total area of magenta area”, “variance value/total area of magenta area”, and “average edge amount of brightness component in magenta area”, and it is determined whether or not the flare is generated.

Note that as the flare determination, it is also possible to perform determination whether or not the flare is generated in a manner that an attitude detection unit of a gyro sensor, an acceleration sensor or the like is provided, the CPU 11 determines an elevation angle with respect to a horizontal direction of the photographic lens 14 from a calculation based on an output value obtained from the attitude detection unit, information regarding a subject distance, a subject brightness, a photographing mode and the like, together with the elevation angle, is transmitted to the flare determination unit 47, and the flare determination unit 47 distinguishes between outdoor and indoor, distinguishes between day and night, and distinguishes whether there exists the sky as a subject in a photographing angle of view when the camera is directed upward, based on the information regarding the elevation angle, the subject distance, the subject brightness, the photographing mode and the like.

When it is determined that the flare is not generated, the AF pixel interpolation unit 45 executes the second pixel interpolation processing in which a pixel value of AF pixel is interpolated by using a pixel value of the AF pixel and pixel values of imaging pixels. In the second pixel interpolation processing, the pixel value of the AF pixel is interpolated by estimating the pixel value from the pixel value (white (W) component) of the AF pixel based on the pixel values of the imaging pixels through a weighted sum.

When it is determined that the flare is generated, the AF pixel interpolation unit 45 executes the third pixel interpolation processing. The third pixel interpolation processing executes a plural times (two times in the present embodiment) of processing in which the pixel values of the imaging pixels in the neighborhood of the AF pixel are corrected by weighting coefficients, and the corrected pixel values of the imaging pixels are smoothed. Although details will be described later, when the correction of the second time is performed, the weighting coefficients are set to “0”. Specifically, in the processing of the second time, the processing of correcting the pixel values of the imaging pixels in the neighborhood of the AF pixel using the weighting coefficients is not conducted, and only the processing of smoothing the pixel values of the imaging pixels is executed. After the plural times of processing, the second pixel interpolation processing in which the pixel value of the AF pixel is interpolated by estimating the pixel value from the pixel value (white (W) component) of the AF pixel based on the corrected pixel values of the imaging pixels through the weighted sum, is executed. Accordingly, it is possible to suppress an influence of color mixture in the flare with respect to the imaging pixels in the neighborhood of the AF pixel. Therefore, at the time of conducting the second pixel interpolation processing, the influence of color mixture is also suppressed in the pixel value obtained as a result of generating the AF pixel as the imaging pixel.

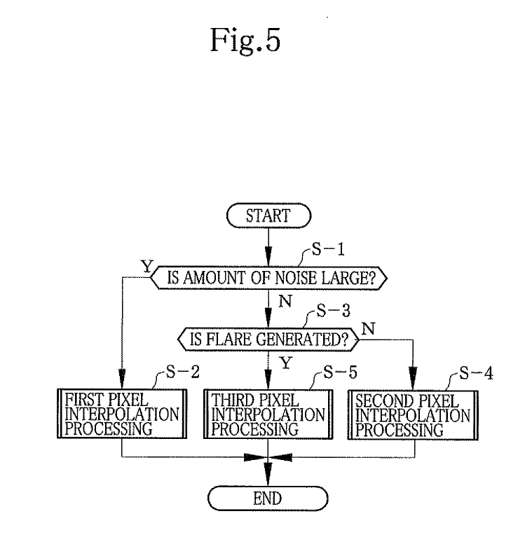

Next, an operation of the AF pixel interpolation unit 45 will be described with reference to FIG. 5. Note that in the present embodiment, since the primary color transmission filters 19 disposed on the respective imaging pixels are arranged in the Bayer pattern, a pixel value of imaging pixel of green color (G) is interpolated at a position of AF pixel represented by the symbol X, and a pixel value of imaging pixel of blue color (B) is interpolated at a pixel position of AF pixel represented by the symbol Y illustrated in FIG. 3. In the explanation hereinafter, a case where a pixel value of imaging pixel of blue color at Y44 and a pixel value of imaging pixel of green color at X45 are respectively interpolated, will be described. A procedure of interpolating a pixel value of imaging pixel in another AF pixel is also similarly conducted.

[Noise Determination]

The CPU 11 transmits the image data transmitted from the A/D 23 to the noise determination unit 46. Further, the CPU 11 transmits the information regarding the temperature of the imaging element 17 at the time of performing photographing, the ISO sensitivity, and the shutter speed to the noise determination unit 46. In this manner, the CPU 11 controls the noise determination unit 46, and determines, with the noise determination unit 46, whether the amount of noise is large or small with respect to the image data (S-1).

The determination of the noise determination unit 46 is executed by referring to noise determination tables. The plurality of noise determination tables are prepared for each temperature range of the imaging element 17, and these tables are previously stored in the non-volatile memory 12. The CPU 11 transmits the noise determination table corresponding to the temperature of the imaging element 17 at the time of obtaining the image data to the noise determination unit 46. As the noise determination table, a table described in [Table 1] is selected when the temperature of the imaging element 17 is less than T1, and a table described in [Table 2] is selected when the temperature is in a range of T1 or more and less than T2, for example. In each table, estimation results of noise determined by the shutter speed (P) and the ISO sensitivity (Q) are determined based on previously conducted experiments.

TABLE 1
TEMPERATURE OF IMAGING
ELEMENT < T1 SHUTTER SPEED P

| | | P₁ | P₂ | P₃ | P₄ | . . . | Pₙ |
|---|---|---|---|---|---|---|---|
| ISO | Q₁ | X | X | X | X | | ◯ |
| SENSITIVITY | Q₂ | X | X | X | X | | ◯ |
| Q | Q₃ | X | X | X | ◯ | | ◯ |
| | | | . | | | | . |
| | | | . | | | | . |
| | | | . | | | | . |
| | Qₘ₋₁ | ◯ | ◯ | ◯ | ◯ | | ◯ |
| | Qₘ | ◯ | ◯ | ◯ | ◯ | . . . | ◯ |

◯: AMOUNT OF NOISE IS SMALL
X: AMOUNT OF NOISE IS LARGE

TABLE 2
T1 ≦ TEMPERATURE OF IMAGING
ELEMENT < T2 SHUTTER SPEED P

| | | P₁ | P₂ | P₃ | P₄ | . . . | Pₙ |
|---|---|---|---|---|---|---|---|
| ISO | Q₁ | X | X | X | X | | ◯ |
| SENSITIVITY | Q₂ | X | X | X | X | | ◯ |
| Q | Q₃ | X | X | X | X | | ◯ |
| | | | . | | | | . |
| | | | . | | | | . |
| | | | . | | | | . |
| | Qₘ₋₁ | X | ◯ | ◯ | ◯ | | ◯ |
| | Qₘ | ◯ | ◯ | ◯ | ◯ | . . . | ◯ |

◯: AMOUNT OF NOISE IS SMALL
X: AMOUNT OF NOISE IS LARGE

When it is determined that the amount of noise is large, the pixel value of the AF pixel is not used, and the first pixel interpolation processing is conducted by using the pixel values of the imaging pixels in the neighborhood of the AF pixel (S-2).

[First Pixel Interpolation Processing]

As the first pixel interpolation processing, a pixel value of AF pixel is determined by performing average interpolation on pixel values of imaging pixels positioned in the neighborhood of the AF pixel, for example. Concretely, in FIG. 3, a pixel value of the AF pixel Y42, a pixel value of the AF pixel Y44, and a pixel value of the AF pixel Y46 disposed instead of B pixels are determined from an expression described in [mathematical expression 1], an expression described in [mathematical expression 2], and an expression described in [mathematical expression 3], respectively.

Y42=(B22+B62)/2 [Mathematical expression 1]

Y44=(B24+B64)/2 [Mathematical expression 2]

Y46=(B26+B66)/2 [Mathematical expression 3]

Further, a pixel value of the AF pixel X43, and a pixel value of the AF pixel X45 disposed instead of G pixels are determined from an expression described in [mathematical expression 4], and an expression described in [mathematical expression 5], respectively.

X43=(G32+G34+G52+G54)/4 [Mathematical expression 4]

X45=(G34+G36+G54+G56)/4 [Mathematical expression 5]

As described above, when the amount of noise is large, the pixel value of the AF pixel is not used, and the pixel value of the AF pixel is estimated only from the pixel values in the neighborhood of the AF pixel, so that it is possible to suppress, as much as possible, that the estimated pixel values of AF pixels vary and thus the interpolation beyond the assumption is performed, resulting in that a color, which does not actually exist, called as a false color is generated and a structure, which does not exist, called as a false structure is generated. Note that the image data in which the pixel values of the AF pixels are interpolated into the pixel values of the imaging pixels is subjected to color interpolation, in the image processing unit 25, from the Bayer pattern into the RGB based on the linear interpolation method, and the resultant is stored in the SDRAM 27 as image data for each RGB.

[Flare Determination]

When the noise determination unit 46 determines that the amount of noise is small, the CPU 11 controls the flare determination unit 47, and determines, with the flare determination unit 47, whether the flare is generated (S-3). The AF pixel interpolation unit 45 executes one of the processings of the second pixel interpolation processing (S-4) when the flare determination unit 47 determines that the flare is not generated, and the third pixel interpolation processing (S-5) when it is determined that the flare is generated.

[Second Pixel Interpolation Processing]

By using the pixel values of the imaging pixels in the neighborhood of the AF pixel, a direction in which a fluctuation value being a fluctuation rate of the pixel values becomes the smallest, is determined. Further, by using the pixel values of the imaging pixels positioned in the direction with the smallest fluctuation, the pixel value of the AF pixel is interpolated.

(Calculation of Direction in which Fluctuation Value Becomes the Smallest)

In order to perform interpolation with respect to the AF pixels at X45 and Y44, the AF pixel interpolation unit 45 uses the pixel values of the imaging pixels in the neighborhood of X45 and Y44, to thereby determine each of values of directional fluctuations H1 to H4 being fluctuation rates of pixel values in four directions, using [mathematical expression 6] to [mathematical expression 9] (S-6). Note that the four directions in the present embodiment indicate a horizontal scanning direction, a vertical scanning direction, a direction of 45 degrees with respect to the horizontal scanning direction, and a direction of 135 degrees with respect to the horizontal scanning direction.

directional fluctuation H1 in the horizontal scanning direction=2×(|G34−G36|+|G54−G56|)+|R33−R35|+|R53−R55|+|B24−B26|+|B64−B66| [Mathematical expression 6]

directional fluctuation H2 in the vertical scanning direction=2×(|G34−G54|+|G36−G56|)+|R33−R53|+|R35−R55|+|B24−B64|+|B26−B66| [Mathematical expression 7]

directional fluctuation H3 in the direction of 45 degrees with respect to the horizontal scanning direction=2×(|G27−G36|+|G54−G63|)+|R35−R53|+|R37−R55|+|B26−B62|+|B28−B64| [Mathematical expression 8]

directional fluctuation H4 in the direction of 135 degrees with respect to the horizontal scanning direction=2×(|G23−G34|+|G56−G67|)+|R33−R55|+|R35−R57|+|B22−B66|+|B24−B68| [Mathematical expression 9]

(Interpolation of pixel values of AF pixels by using pixel values of neighboring imaging pixels in accordance with direction with the smallest fluctuation value)

The AF pixel interpolation unit 45 selects the direction with the directional fluctuation of the smallest value among the directional fluctuations H1 to H4 determined in step S-6, and determines, by using the pixel values of the imaging pixels positioned in that direction, a pixel value G_{X45} of imaging pixel of G at the position of the AF pixel X45 and a pixel value By44 of imaging pixel of B at the position of the AF pixel Y44, using an expression, among [mathematical expression 10] to [mathematical expression 13], corresponding to the selected direction (S-7). Accordingly, by using the pixel values of the imaging pixels positioned in the direction with the small fluctuation, it becomes possible to perform the interpolation with respect to the AF pixels at X45, Y44 and the like more correctly.

When the directional fluctuation H1 is the smallest

B_{Y44}=(B24+B64)/2

G_{X45}=(G34+G36+G54+G56)/4[ Mathematical expression 10]

When the directional fluctuation H2 is the smallest

B_{Y44}=(B24+B64)/2

G_{X46}=(G25+G65)/2 [Mathematical expression 11]

When the directional fluctuation H3 is the smallest

B_{Y44}=(326+362)/2

G_{X45}=(G36+G54)/2 [Mathematical expression 12]

When the directional fluctuation H4 is the smallest

B_{Y44}=(B22+B366)/2

G=(G34+G56)/2 [Mathematical expression 13]

The AF pixel interpolation unit 45 calculates a directional fluctuation H5 of the pixel values of the AF pixels in the horizontal scanning direction being an arranging direction of the AF pixels, by using, for example, pixel values W44 and W45 of white light at Y44 and X45 of the AF pixels, and [mathematical expression 14].

H5=|W44−W45| [Mathematical expression 14]

The AF pixel interpolation unit 45 determines whether or not the value of the directional fluctuation H5 exceeds a threshold value Th1 (S-8). When the directional fluctuation H5 has a value exceeding the threshold value Th1 (YES side), the AF pixel interpolation unit 45 sets the interpolated values of B_{Y44} and G_{X45} determined in step S-7 to the pixel values of the imaging pixels at Y44 and X45, and updates the image data. The image processing unit 25 performs pixel interpolation of three colors with respect to the updated image data to generate image data of three colors, and records the image data of three colors in the SDRAM 27 via the bus 26 (S-9).

On the other hand, when the directional fluctuation H5 becomes equal to or less than the threshold value Th1 (NO side), the image processing unit 25 proceeds to S-10. Note that when a 12-bit image is processed, for example, the threshold value Th1 may be set to a value of about 512.

The AF pixel interpolation unit 45 determines whether or not the directional fluctuation H2 determined in step S-6 exceeds a threshold value Th2 (S-10). When the directional fluctuation H2 has a value exceeding the threshold value Th2 (YES side), the AF pixel interpolation unit 45 sets the interpolated values of B_{Y44} and Gₓ₄₅ determined in step S-7 to the pixel values of the imaging pixels at Y44 and X45, and updates the image data. The image processing unit 25 performs pixel interpolation of three colors with respect to the updated image data to generate image data of three colors, and stores the image data of three colors in the SDRAM 27 via the bus 26 (S-9).

On the other hand, when the directional fluctuation H2 becomes equal to or less than the threshold value Th2 (NO side), the image processing unit 25 proceeds to S-11. Note that when the 12-bit image is processed, for example, the threshold value Th2 may be set to a value of about 64.

After that, the AF pixel interpolation unit 45 calculates an average pixel value <W44> of white light in the AF pixel at Y44 and the like having the sensitivity to the luminous flux from the right side and the like, by using pixel values of imaging pixels of color components R, G and B positioned in the neighborhood of the AF pixel (S-11). Concretely, when the image processing unit 25 determines that the directional fluctuation H2 is the smallest, for example, in step S-6, 824 and B64 in the expression described in [mathematical expression 11] are used as the pixel values of the imaging pixels of B. Meanwhile, regarding the pixel values of R and G, interpolation calculation of pixel values of R and G at the positions of imaging pixels 824 and 864 of B is conducted by using four expressions described in [mathematical expression 15].

(1)R_{B24}=(R13+R15+R33+R35)/4

(2)G_{B24}=(G14+G23+G25+G34)/4

(3)R_{B64}=(R53+R55+R73+R75)/4

(4)G₁₄=(G54+G63+G65+G74)/4 [Mathematical expression 15]

Subsequently, the AF pixel interpolation unit 45 calculates pixel values W24 and W64 of white light at the positions of the imaging pixels 824 and B64, through a weighted sum represented by expressions described in [mathematical expression 16] by using weighted coefficients WR, WG and WB of R, G and B transferred from the CPU 11. Note that a method of determining the weighted coefficients WR, WG and WB will be described later.

W24=WR×R_{B24}+WG×G_{B24}+WB×B24

W64=WR×R_{B64}+WG×G_{B64}+WB×B64 [Mathematical expression 16]

Further, the image processing unit 25 calculates the average pixel value <W44> of white light at Y44=(W24+W64)/2.

The AF pixel interpolation unit 45 calculates an average pixel value <W45> of white light in the AF pixel at X45 and the like having the sensitivity to the luminous flux from the left side and the like, by using pixel values of imaging pixels of color components R, G and B positioned in the neighborhood of the AF pixel, similar to the case of step S-11 (S-12). When the image processing unit 25 determines that the directional fluctuation H2 is the smallest, in step S-6, G25 and G65 in the expression described in [mathematical expression 11] are used as the pixel values of the imaging pixels of G. Meanwhile, regarding the pixel values of R and B, interpolation calculation of pixel values of R and B at the positions of imaging pixels G25 and G65 of G is conducted by using four expressions described in [mathematical expression 17],

(1)R_{G25}=(R15−FR35)/2

(2)B_{G25}=(B24+B26)/2

(3)R_{G65}=(R55+R75)/2

(4)B_{G65}=(B64+B66)/2 [Mathematical expression 17]

Subsequently, the AF pixel interpolation unit 45 calculates pixel values W25 and W65 of white light at the positions of the imaging pixels G25 and G65, through a weighted sum represented by expressions described in [mathematical expression 18].

W25=WR×R_{G25}+WG×G25+WB×B_{G25}

W65=WR×R_{G65}+WG×G25+WB×B_{G65} [Mathematical expression 18]

Subsequently, the image processing unit 25 calculates the average pixel value <W45> of white light at X45=(W25+W65)/2.

The AF pixel interpolation unit 45 determines a high frequency component of pixel value of white light in each AF pixel of the imaging element 17, by using the average pixel values of white light determined in S-11 and S-12 (S-13). At first the AF pixel interpolation unit 45 determines an average pixel value of white light at the pixel position of each AF pixel, from the pixel value of each AF pixel of the imaging element 17. Specifically, the pixel value of each AF pixel is a value as a result of pupil-dividing the luminous flux from the left side or the right side. Therefore, in order to obtain the pixel value of white light at the position of each AF pixel, there is a need to add mutual pixel values of luminous flux from the left side and the right side. Accordingly, the AF pixel interpolation unit 45 of the present embodiment calculates, by using the pixel value of each AF pixel and the pixel values of the adjacent AF pixels, the average pixel values of white light at the positions of AF pixels Y44 and X45, using expressions described in [mathematical expression 19].

<W44>′=W44+(W43+W45)/2

<W45>′ W45+(W44+W46)/2 [Mathematical expression 19]

Note that since the pixel value of white light at the position of each AF pixel is calculated by using the pixel values of the AF pixels adjacent in the arranging direction of the AF pixels, in [mathematical expression 19] explained in step S-13, when there is a large fluctuation in the arranging direction, the calculation of high frequency component is incorrectly performed, resulting in that a resolution in the arranging direction of the pixel values of white light may be lost. Therefore, the aforementioned step S-8 is designed to stop the addition of high frequency component, when there is a large fluctuation in the arranging direction.

After that, the AF pixel interpolation unit 45 determines, from expressions described in [mathematical expression 20], high frequency components HF_{Y44} and HF_{X45} of white light at the positions of Y44 and X45.

HF_{Y44}=<W44>′−<W44>

HF_{X45}=<W45>′−<W45> [Mathematical expression 20]

The AF pixel interpolation unit 45 determines whether or not a ratio of the high frequency component HF of the pixel value of white light at the position of each AF pixel determined in step S-13 to the pixel value of the white light is smaller than a threshold value Th3 (which is about 10%, for example, in the present embodiment) (S-14). If the high frequency component HF is smaller than the threshold value Th3 (YES side), the AF pixel interpolation unit 45 sets the interpolated values of B_{Y44} and G_{X45} determined in step S-12 to the pixel values of the imaging pixels at Y44 and X45, and updates the image data. The image processing unit 25 performs pixel interpolation of three colors with respect to the updated image data to generate image data of three colors, and stores the image data of three colors in the SDRAM 27 via the bus 26 (S-9).

On the other hand, if the high frequency component HF is equal to or more than the threshold value Th3 (NO side), the AF pixel interpolation unit 45 proceeds to step S-15. Note that explanation regarding the value of the threshold value Th3 will be made together with the later explanation regarding the weighted coefficients WR, WG and WB. The AF pixel interpolation unit 45 calculates color fluctuations VR, VGr, VB and VGb of the pixel values of the imaging pixels of each color component R, G or B in the neighborhood of Y44 and X45 (S-15). Here, each of the color fluctuations VGr and VGb indicates color fluctuations of G at the positions of imaging pixels of R or B. The AF pixel interpolation unit 45 determines the color fluctuations VR and VGr based on two expressions described in [mathematical expression 21].

$$\begin{matrix}[ Mathematical expression 21 ] & \\ VR = \vert R 33 - R 53 \vert + \vert R 35 - R 55 \vert + \vert R 37 - R 57 \vert & ( 1 ) \\ VGr = \vert ( G 32 + G 34 ) / 2 - ( G 52 + G 54 ) / 2 \vert + \vert ( G 34 + G 36 ) / 2 - ( G 54 + G 56 ) / 2 \vert + \vert ( G 36 + G 38 ) / 2 - ( G 56 + G 58 ) / 2 \vert & ( 2 )\end{matrix}$$

Note that the AF pixel interpolation unit 45 of the present embodiment calculates the value of VGr after determining an average value of pixel values of G at the positions R33, R35, R37, R53, R55 and R57 of the imaging pixels of R.

Meanwhile, the AF pixel interpolation unit 45 determines the color fluctuations VB and VGb based on two expressions described in [mathematical expression 22].

$$\begin{matrix}[ Mathematical expression 22 ] & \\ VB = \vert B 22 - B 62 \vert + \vert B 24 - B 64 \vert + \vert B 26 - B 66 \vert & ( 1 ) \\ VGb = \vert ( G 21 + G 23 ) / 2 - ( G 61 + G 63 ) / 2 \vert + \vert ( G 23 + G 25 ) / 2 - ( G 63 + G 65 ) / 2 \vert + \vert ( G 25 + G 27 ) / 2 - ( G 65 + G 67 ) / 2 \vert & ( 2 )\end{matrix}$$

Note that the AF pixel interpolation unit 45 of the present embodiment calculates the value of VGb after determining an average value of pixel values of G at the positions 822, B24, B26, B62, B64 and B66 of the imaging pixels of B.

The AF pixel interpolation unit 45 uses the color fluctuations VR, VGr, V13 and VGb calculated in step S-15 to calculate color fluctuation rates K_{WG} and K_{WB} to white color of the color components G and B (S-16). First, the AF pixel interpolation unit 45 determines, by using the color fluctuations VR, VGr, VB and VGb, color fluctuations VR2, VG2 and VB2 from three expressions described in [mathematical expression 23].

(1)VR2=(VR+α)×(VGb+α)

(2)VB2=(VB+α)×(VGr+α)

(3)VG2=(VGb+α)×(VGr+α) [Mathematical expression 23]

Here, α is an appropriate constant for stabilizing the value of the color fluctuation rate, and α may be set to a value of about 256, when the 12-bit image is processed, for example.

Subsequently, the image processing unit 25 uses the color fluctuations VR2, VG2 and VB2 to calculate a color fluctuation VW to white color, based on an expression described in [mathematical expression 24].

VW=VR2+VG2+VB2 [Mathematical expression 24]

Accordingly, the AF pixel interpolation unit 45 calculates the color fluctuation rates K_{WG} and K_{WB} from [mathematical expression 25].

K_{WG}=VG2/VW

K_{WB}=VB2/VW [Mathematical expression 25]

The AF pixel interpolation unit 45 uses the high frequency component HF of the pixel value of white light at the position of each AF pixel determined in step S-13, and the color fluctuation rates K_{WG} and K_{WB} calculated in step S-16 to calculate high frequency components of the pixel values of the color components G and B at the positions of respective AF pixels, from expressions described in [mathematical expression 26] (S-17).

HFB_{Y44}=HF_{Y44}×K_{WB}

HFG_{X45}=HF_{X45}×K_{WG} [Mathematical expression 26]

The AF pixel interpolation unit 45 adds the high frequency components of the respective color components in the respective AF pixels determined in step S-17 to the pixel values of the imaging pixels interpolated and determined in step S-7 (S-18). The CPU 11 calculates imaging pixel values B′ and G′ at Y44 and X45, respectively, based on expressions described in [mathematical expression 27], for example.

B′_{Y44}=B_{Y44}+HFB_{Y44}

G′_{X45}=G_{X45}+HFG_{X45} [Mathematical expression 27]

The AF pixel interpolation unit 45 sets the pixel values of B′_{Y44}, G′_{X45} and the like interpolated and determined at the positions of AF pixels at Y44, X45 and the like, to the pixel values of the imaging pixels at the respective positions, and updates the image data. The image processing unit 25 converts the updated image data into image data in which one pixel has three colors, and stores the resultant in the SDRAM 27 (S-9).

Note that even if there is no fluctuation in the arranging direction of AF pixels, the high frequency components of the pixel values of white light have a slight error due to a variation between the weighted sum of the spectral characteristics of the imaging pixels of the respective color components and the spectral characteristics of the AF pixels. When there is no large fluctuation in the image in the vertical scanning direction (direction that intersects with the arranging direction of AF pixels), the accuracy of interpolation value is sufficient even if the high frequency component is not added, and there is a possibility that the addition of high frequency component only generates a false structure due to an error. Accordingly, in such a case, the addition of high frequency component is suppressed in step S-10. Further, when the calculated high frequency component is small enough, the accuracy of interpolation value is sufficient even if the high frequency component is not added, and there is a possibility that the addition of high frequency component only generates a false structure due to an error. Accordingly, it is designed that, in such a case, the addition of high frequency component is suppressed in S-10.

Next, the method of determining the weighted coefficients WR, WG and WB will be described together with the threshold value Th3. In order to determine such weighted coefficients and threshold value, the imaging element 17 to be incorporated in a product or an imaging element having the same performance as that of the imaging element 17 is prepared. An illumination with substantially uniform illuminance is irradiated to the imaging element 17 while changing wavelength bands in various ways, and imaged image data with respect to each wavelength band is obtained. Further, to the imaged image data n of each wavelength band, the pixel values of AF pixels with different pupil division are added as in the expression described in [mathematical expression 19], to thereby calculate a pixel value Wn of white light. At the same time, extraction is also performed on pixel values Rn, Gn, and Bn of imaging pixels of respective color components positioned in the neighborhood of the AF pixel.

Further, as a function of unknown weighted coefficients WR, WG and WB, a square error E is defined as [mathematical expression 28].

E=Σn(WR×Rn+WG×Gn+WB×Bn−Wn)² [Mathematical expression 28]

Further, the weighted coefficients WR, WG and WB that minimize E are determined (the weighted coefficients WR, WG and WB that make a value obtained by partially differentiating E with each WR, WG or WB to “0”, are determined). By determining the weighted coefficients WR, WG and WB as described above, the weighted coefficients with which the spectral characteristics of the AF pixel are represented by the weighted sum of the spectral characteristics of the imaging pixels of respective color components R, G and B are determined. The weighted coefficients WR, WG and W13 determined as above are recorded in the non-volatile memory 12 of the electronic camera 10.

Further, an error rate Kn for each of the pieces of imaged image data n is determined based on the determined weighted coefficients WR, WG and WB, using an expression described in [mathematical expression 29].

Kn=|WR×Rn+WG×Gn+WB×Bn−Wn|/Wn [Mathematical expression 29]

Further, a maximum value of Kn is determined, and is recorded in the non-volatile memory 12 as the threshold value Th3.

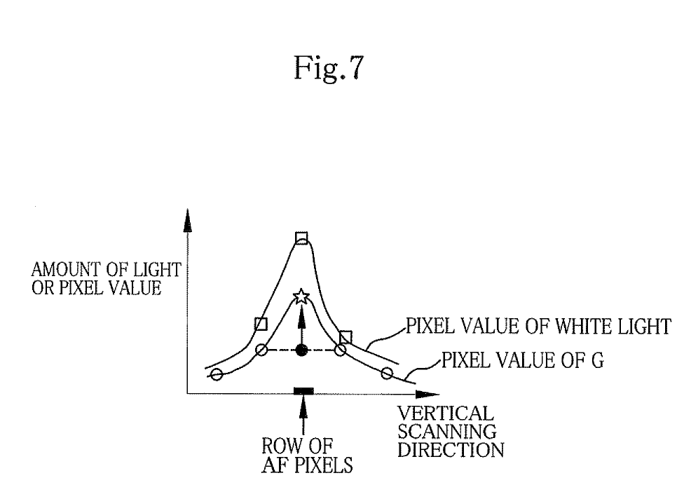

FIG. 7 represents an example of image structure in which an effect of the present embodiment is exerted. FIG. 7 is a longitudinally-sectional view of an image structure of longitudinal five pixels including a convex structure (bright line or points), in which a horizontal axis indicates a vertical scanning direction (y-coordinate), and a vertical axis indicates a light amount or a pixel value. Further, the convex structure is positioned exactly on the AF pixel row arranged in the horizontal scanning direction.

Marks o in FIG. 7 indicate pixel values imaged by the imaging pixels of G. However, since the imaging pixel of G does not exist at the position of the AF pixel, the pixel value of G at that position cannot be obtained. Therefore, when the convex structure is positioned exactly at the position of the AF pixel, the convex structure in FIG. 7 cannot be reproduced from only the pixel values of the imaging pixels of G in the neighborhood of the AF pixel. Actually, in S-7, the pixel value of G (mark [symbol] in FIG. 7) interpolated and determined at the position of the AF pixel by using the pixel values of the imaging pixels of G in the neighborhood of the AF pixel does not reproduce the convex structure.

Meanwhile, at the position of the AF pixel, a pixel value of white light is obtained. However, although a normal pixel receives light passing through an entire area of the pupil, the AF pixel receives only light passing through the right side or the left side of the pupil, so that by adding the adjacent AF pixels which are different in pupil division, a pixel value of normal white light (light passing through the entire area of the pupil) is calculated ([mathematical expression 19]).

Further, by interpolating and generating the other color components R and B at the position of the imaging pixel of G in the neighborhood of the AF pixel, and determining the weighted sum of the color components R, G and B, it is possible to determine the pixel value of white light with sufficient accuracy in many cases ([mathematical expression 16] and [mathematical expression 18]).

Marks □ in FIG. 7 represent a distribution of the pixel values of white light determined as above. In many cases, a high frequency component of the pixel value of white light and a high frequency component of the pixel value of the color component G are proportional to each other, so that the high frequency component calculated from the pixel value of white light has information regarding the convex structure component of the pixel value of G. Accordingly, the high frequency component of the pixel value of G is determined based on the high frequency component of the pixel value of white light, and the determined value is added to data indicated by the mark [symbol] , resulting in that a pixel value of G indicated by a mark is obtained, and the convex structure is reproduced ([mathematical expression 26]).

[Third Pixel Interpolation Processing]

The AF pixel interpolation unit 45 selects and executes the third pixel interpolation processing, when the amount of noise is small based on the result of determination made by the noise determination unit 46, and the flare determination unit 47 determines that the flare is easily generated.

The third pixel interpolation processing is processing in which processing of correcting the pixel values of the imaging pixels in the neighborhood of the AF pixel using weighting coefficients and smoothing the corrected pixel values of the imaging pixels, is performed two times while changing the weighting coefficients with respect to the pixel values of the imaging pixels, and thereafter, the aforementioned second pixel interpolation processing is executed. Hereinafter, explanation will be made on the third pixel interpolation processing with respect to two columns of the AF pixel X43 and the AF pixel Y44 in FIG. 3.

[Correction of Pixel Values of Imaging Pixels in the Neighborhood of AF Pixel Columns Using Weighting Coefficients]

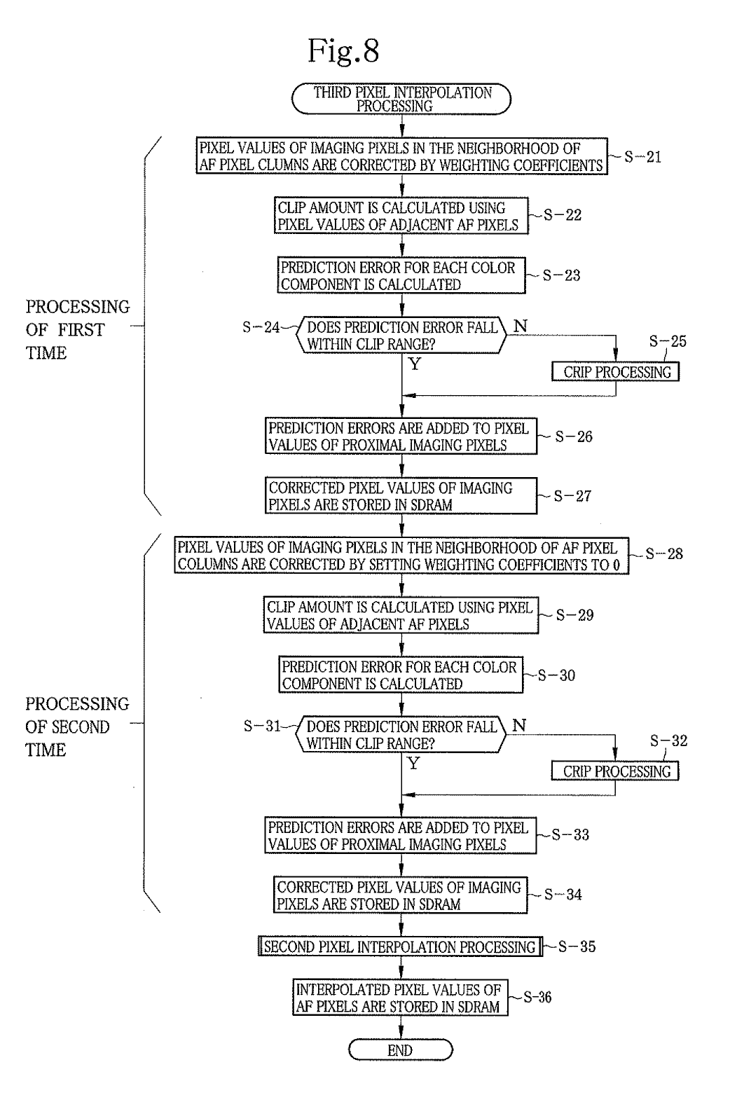

As illustrated in FIG. 8, the AF pixel interpolation unit 45 determines whether or not the pixel values of the imaging pixels arranged in the neighborhood of the AF pixel columns become equal to or more than a threshold value MAX_RAW, and performs correction using set weighting coefficients based on the determination result (S-21). Here, the threshold value MAX_RAW is a threshold value for determining whether or not the pixel value is saturated.

When the pixel value of the imaging pixel becomes equal to or more than the threshold value MAX_RAW, the AF pixel interpolation unit 45 does not perform the correction on the pixel value of the imaging pixel. On the other hand, when the pixel value of the imaging pixel becomes less than the threshold value MAX_RAW, the AF pixel interpolation unit 45 corrects the pixel value of the imaging pixel by subtracting a value of the weighted sum using the weighting coefficients from the original pixel value.

The AF pixel interpolation unit 45 corrects the pixel values of the imaging pixels of R color component using [mathematical expression 30] to [mathematical expression 33].

R13′=R13−(R3U_{—}0×R33+R3U_{—}1×G34+R3U_{—}2×B24) [Mathematical expression 30]

R33′=R33−(R1U_{—}0×R33+R1U_{—}1×G34+R1U_{—}2×B24) [Mathematical expression 31]

R53′=R53−(R1S_{—}0×R53+R1S_{—}1×G54+R1S_{—}2×B64) [Mathematical expression 32]

R73′=R73−(R3S_{—}0×R53+R3S_{—}1×G54+R3S_{—}2×B64) [Mathematical expression 33]

Here, R1U_0, R1U_1, R1U_2, R1S_0, R1S_1, R1S_2, R3U_0, R3U_1, R3U_2, R3S_0, R3S_1, R3S_2 are the weighting coefficients. Note that in the weighting coefficients, a character S indicates a position above the AF pixel, and a character U indicates a position below the AF pixel.

The AF pixel interpolation unit 45 corrects the pixel values of the imaging pixels of G color component using [mathematical expression 34] to [mathematical expression 39].

G14′=G14−(G3U_{—}0×R33+G3U_{—}1×G34+G3U_{—}2×B24) [Mathematical expression 34]

G23′=G23−(G2U_{—}0×R33+G2U_{—}1×G34+G2U_{—}2×B24) [Mathematical expression 35]

G34′=G34−(G1U_{—}0×R33+G1U_{—}1×G34+G1U_{—}2×B24) [Mathematical expression 36]

G54′=G54−(G1S_{—}0×R53+G1S_{—}1×G54+G2S_{—}2×B64) [Mathematical expression 37]

G63′=G63−(G2S_{—}0×R53+G2S_{—}1×G54+G2S_{—}2×B64) [Mathematical expression 38]

G74′=G74−(G3S_{—}0×R53+G3S_{—}1×G54+G3S_{—}2×B64) [Mathematical expression 39]

Here, G1U_0, G1U_{—1, G1U}_2, G1S_0, G1S_1, G1S_2, G2U_0, G2U_1, G2U_2, G2S_0, G2S_1, G2S_2, G3U_0, G3U_1, G3U_2, G3S_0, G3S_1, G3S_2 are the weighting coefficients.

Further, the AF pixel interpolation unit 45 corrects the pixel values of the imaging pixels of B color component using [mathematical expression 40] and [mathematical expression 41].

B24′B24−(B2U_{—}0×R33+B2U_{—}1×G34+B2U_{—}2×B24) [Mathematical expression 40]

B64′=B64−(B2S_{—}0×R53+B2S_{—}1×G54+B2S_{—}2×B64) [Mathematical expression 41]

Here, B2U_0, BALL B2U_2, B2S_0, B2S_1, B2S_2 are the weighting coefficients.

[Calculation of Clip Amount Using Pixel Values of Adjacent AF Pixels]

The AF pixel interpolation unit 45 reads the pixel values X43 and Y44 of the adjacent AF pixels, and determines a clip amount Th_LPF by using [mathematical expression 42] (S-22).

Th_{—}LPF=(X43+Y44)×K_{—}Th_{—}LPF [Mathematical expression 42]

Here, K_Th_LPF is a coefficient, which applies a value of about “127”. The larger the value of the coefficient K_Th_LPF, the higher the effect of the smoothing processing.

[Calculation of Prediction Error for Each Color Component]

The AF pixel interpolation unit 45 calculates a difference between a pixel value of the imaging pixel at a position far from the AF pixel 41 (distant imaging pixel) and a pixel value of the imaging pixel at a position close to the AF pixel 41 (proximal imaging pixel), among the imaging pixels with the same color component arranged on the same column, as a prediction error, by using [mathematical expression 43] and [mathematical expression 44] (S-23).

deltaRU=R13′−R33′

deltaRS=R73′−R53′ [Mathematical expression 43]

deltaGU=G14′−G34′

deltaGS=G74′−G54′ [Mathematical expression 44]

[Determination Whether or not Prediction Error Exceeds Clip Range]

The AF pixel interpolation unit 45 determines whether or not each value of the prediction errors deltaRU, deltaRS, deltaGU and deltaGS determined through [mathematical expression 43] and [mathematical expression 44] falls within a clip range (−Th_LPF to Th_LPF) based on the clip amount determined in [mathematical expression 42] (S-24).

[Clip Processing]

The AF pixel interpolation unit 45 performs clip processing on the prediction error, among the prediction errors deltaRU, deltaRS, deltaGU and deltaGS, which is out of the clip range (S-25). Here, the clip processing is processing of clipping the value of the prediction error which is out of the clip range to make the value fall within the clip range.

[Addition of Prediction Errors to Pixel Values of Proximal Imaging Pixels]

The AF pixel interpolation unit 45 adds the prediction errors to the pixel values of the proximal imaging pixels on the respective columns, through [mathematical expression 45] (S-26). Here, the prediction errors have the values determined through [mathematical expression 43] and [mathematical expression 44], or the clipped values.

R33″=R33′+deltaRU

R53″=R53′+deltaRS

G34″=G34′+deltaGU

G54″=G54′deltaGS [Mathematical expression 45]

Accordingly, the pixel values of the distant imaging pixels and the pixel values of the proximal imaging pixels being the pixel values of the imaging pixels in the neighborhood of the AF pixel columns are respectively corrected, and further, by the smoothing processing using the prediction errors, the pixel values of the proximal imaging pixels are corrected.

[Storage of Corrected Pixel Values of Imaging Pixels in SDRAM]

The AF pixel interpolation unit 45 stores the pixel values of the distant imaging pixels corrected by the weighting coefficients and the pixel values of the proximal imaging pixels corrected by the prediction errors, in the SDRAM 27 (S-27).

When the processing of the first time is completed, the processing of the second time is executed.

[Correction of Pixel Values of Imaging Pixels in the Neighborhood of AF Pixel Columns Using Weighting Coefficients]

The AF pixel interpolation unit 45 determines, by using the pixel values of the imaging pixels corrected through the processing of the first time, whether or not the pixel values of these imaging pixels become equal to or more than the threshold value MAX_RAW. Based on a result of the determination, the correction is performed using the set weighting coefficients (S-28). Here, the threshold value MAX_RAW is a threshold value for determining whether or not the pixel value is saturated, and the same value as that in the processing of the first time (S-21) is used.

When the pixel value of the imaging pixel becomes equal to or more than the threshold value MAX_RAW, the AF pixel interpolation unit 45 does not perform the correction on the pixel value of the imaging pixel. When the pixel value of the imaging pixel becomes less than the threshold value MAX_RAW, the AF pixel interpolation unit 45 performs correction by changing all of the weighting coefficients in the above-described [mathematical expression 30] to [mathematical expression 41] to “0”. Specifically, when the processing is conducted, the pixel values of the imaging pixels arranged in the neighborhood of the AF pixel columns stay as their original pixel values.

(Calculation of Clip Amount Using Pixel Values of Adjacent AF Pixels)

The AF pixel interpolation unit 45 reads the pixel values X43 and Y44 of the adjacent AF pixels, and determines a clip amount Th_LPF by using the above-described [mathematical expression 42] (S-29). Here, as the value of K_Th_LPF, the same value as that in the processing of the first time is used.

[Calculation of Prediction Error for Each Color Component]

The AF pixel interpolation unit 45 calculates a difference between a pixel value of the distant imaging pixel and a pixel value of the proximal imaging pixel, among the imaging pixels with the same color component arranged on the same column, as a prediction error, by using the above-described [mathematical expression 43] and [mathematical expression 44] (S-30).

[Determination Whether or not Prediction Error Exceeds Clip Range]

The AF pixel interpolation unit 45 determines whether or not each value of the prediction errors deltaRU, deltaRS, deltaGU and deltaGS determined by the above-described [mathematical expression 43] and [mathematical expression 44] falls within a clip range (−Th_LPF to Th_LPF) based on the clip amount determined through [mathematical expression 42] (S-31).

[Clip Processing]

The AF pixel interpolation unit 45 performs clip processing on the prediction error, among the prediction errors deltaRU, deltaRS, deltaGU and deltaGS, which is out of the clip range (S-32).

[Addition of Prediction Errors to Pixel Values of Proximal Imaging Pixels]

The AF pixel interpolation unit 45 adds the prediction errors to the pixel values of the proximal imaging pixels on the respective columns, using the above-described [mathematical expression 45] (S-33).

Accordingly, in the processing of the second time, the pixel values of the proximal imaging pixels are further corrected using the prediction errors.

[Storage of Corrected Pixel Values of Imaging Pixels in SDRAM]

The AF pixel interpolation unit 45 stores the pixel values of the distant imaging pixels corrected by the weighting coefficients and the pixel values of the proximal imaging pixels corrected by the prediction errors, in the SDRAM 27 (S-34).

As described above, in the third pixel interpolation processing, the above-described correction processing is repeatedly executed two times. After the correction processing is repeatedly executed two times, the second pixel interpolation processing is carried out.

[Second Pixel Interpolation Processing]

The AF pixel interpolation unit 45 executes the above-described second pixel interpolation processing by using the pixel values of the imaging pixels stored in the SDRAM 27 (S-35). Accordingly, the pixel values of the imaging pixels corresponding to the AF pixels are calculated. Specifically, the pixel values of the AF pixels are interpolated.

[Storage of Interpolated Pixel Values of AF Pixels in SDRAM]

The AF pixel interpolation unit 45 stores the pixel values of the AF pixels interpolated through the second pixel interpolation processing (S-35), in the SDRAM 27.

In the third pixel interpolation processing, by repeatedly executing the correction processing two times, the smoothing processing with respect to the pixel values of the imaging pixels in the neighborhood of the AF pixel columns is effectively performed. When the smoothing processing is effectively performed, it is possible to reduce the influence of color mixture due to the flare generated in the imaging pixel adjacent to the AF pixel. Further, since the interpolation processing with respect to the AF pixel is conducted by using the pixel value of the imaging pixel in which the influence of color mixture is reduced, it is possible to obtain, also in the AF pixel, the pixel value in which the influence of color mixture due to the generated flare is reduced. Specifically, it is possible to obtain an image in which the influence of flare is reduced.

In the present embodiment, explanation is made on the assumption that the interpolation processing is performed on the AF pixel in the image. However, it is also possible to apply the present embodiment to an electronic camera having a noise reduction (NR) function. For example, in the photographing based on a so-called long exposure in which the shutter 16 is opened for 30 seconds or more, the photographing in which the shutter 16 is opened, and the photographing in which the shutter 16 is closed, are respectively performed in sequence. Each of images obtained through the above photographing (a recording image, a blackout image) is subjected to the noise determination by the noise determination unit 46 and the flare determination by the flare determination unit 47, and is subjected to any one of the aforementioned pixel interpolation processings. Further, each pixel value of the blackout image is subtracted from each pixel value of the recording image after performing these processings on the images, thereby generating a recording image after removing a fixed pattern noise. At this time, by performing the aforementioned pixel interpolation processing on each of the recording image and the blackout image, the recording image and the blackout image in which the occurrence of false color is suppressed, are generated. Specifically, a recording image to be finally obtained corresponds to an image in which the occurrence of false color is suppressed. Such long-exposure photographing is often performed under a photographing condition in which a brightness of subject such as the starry sky at night is low, so that it is also possible to design such that the flare determination by the flare determination unit 47 is not performed and only the noise determination by the noise determination unit 46 is performed to decide either the first pixel interpolation processing or the second pixel interpolation processing is executed.

Note that in the present embodiment, the arranging direction of the AF pixels is set to the horizontal scanning direction, but, the present invention is not limited to this, and the AF pixels may also be arranged in the vertical scanning direction or another direction.

Note that in the present embodiment, each of the AF pixels is set as the focus detecting pixel that pupil-divides the luminous flux from the left side or the right side, but, the present invention is not limited to this, and each of the AF pixels may also be a focus detecting pixel having a pixel that pupil-divides the luminous flux from the left side and the right side.

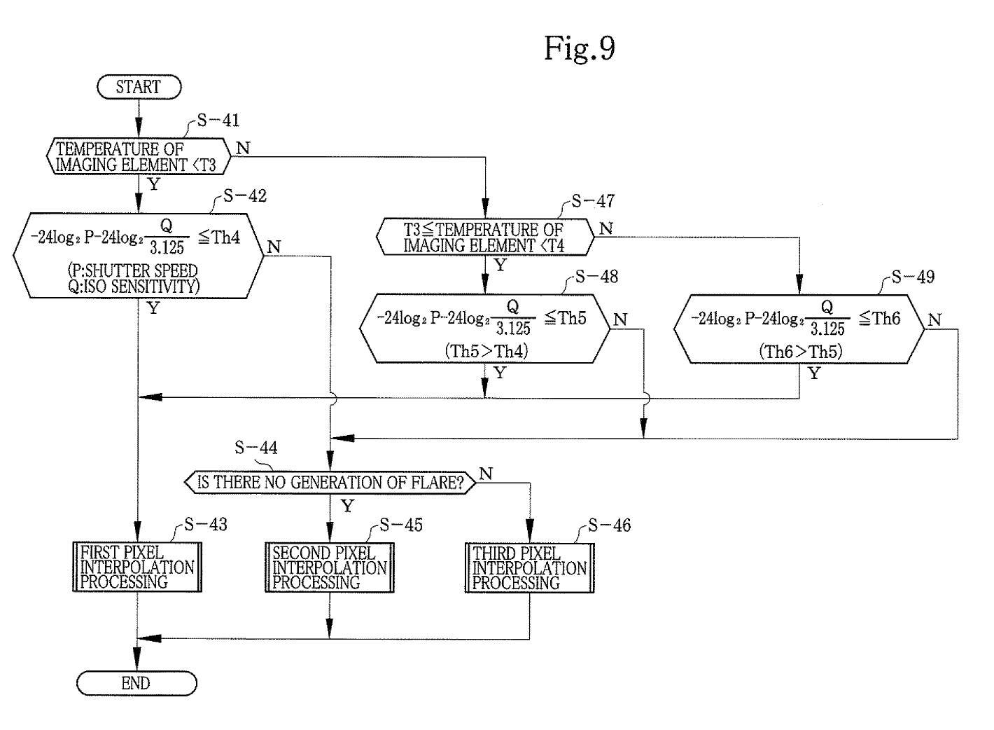

Note that in the present embodiment, the explanation regarding the noise determination referring to the noise determination table (flow chart in FIG. 5) is made, but, the present invention is not limited to this, and it is also possible to conduct noise determination based on a conditional expression, for example. Hereinafter, the noise determination using the conditional expression will be described based on a flow chart in FIG. 9.

[Determination Whether Temperature of Imaging Element is Less than T3]

The CPU 11 transmits information regarding a temperature of the imaging element 17 at the time of performing photographing, an ISO sensitivity and a shutter speed, to the noise determination unit 46. The noise determination unit 46 determines whether or not the temperature of the imaging element 17 at the time of performing photographing transmitted from the CPU 11 is less than T3 (S-41).

[Determination Whether −24 log₂ P−24 log₂ (Q/3.125)≦Th4 is Satisfied]

When the temperature of the imaging element 17 becomes less than T3, the noise determination unit 46 determines whether or not the transmitted ISO sensitivity Q and shutter speed P satisfy [mathematical expression 46] (S-42).

24 log₂P−24 log₂(Q/3.1.25)≦Th4 [Mathematical expression 46]

Note that Th4 is a threshold value. When the above-described expression is satisfied, it is determined that the amount of noise is large, and when the expression is not satisfied, it is determined that the amount of noise is small.

For example, when the noise determination unit 46 determines that the amount of noise is large, the AF pixel interpolation unit 45 executes the first pixel interpolation processing. On the other hand, when the noise determination unit 46 determines that the amount of noise is small, the flare determination unit 47 executes the determination whether there is no generation of flare (S-45).

[Determination Whether there is No Generation of Flare]

When the noise determination unit 46 determines that the amount of noise is small, the CPU 11 controls the flare determination unit 47, and determines, with the flare determination unit 47, whether there is no generation of flare (S-44). The AF pixel interpolation unit 45 executes one of the processings of the second pixel interpolation processing (S-45) when the flare determination unit 47 determines that the flare is not generated, and the third pixel interpolation processing (S-46) when it is determined that the flare is generated.

[Determination Whether Temperature of Imaging Element is T3 or More and Less than T4]

When the temperature of the imaging element 17 is T3 or more in the determination of temperature of the imaging element 17 at the time of performing imaging described above (S-41), the noise determination unit 46 determines whether the temperature of the imaging element is T3 or more and less than T4 (S-47).

[Determination Whether −24 log₂ P−24 log₂ (Q/3.125)≦Th5 is Satisfied]

When the temperature of the imaging element 17 becomes T3 or more and less than T4, the noise determination unit 46 determines whether or not the transmitted ISO sensitivity Q and shutter speed P satisfy [mathematical expression 47] (S-48).

−24 log₂P−24 log₂(Q/3.125)≦Th5 [Mathematical expression 47]

Note that Th5 is a threshold value (Th5>Th4). When the above-described expression is satisfied, it is determined that the amount of noise is large, and when the expression is not satisfied, it is determined that the amount of noise is small.

For example, when the noise determination unit 46 determines that the amount of noise is large, the AF pixel interpolation unit 45 executes the first pixel interpolation processing (S-43). On the other hand, when the noise determination unit 46 determines that the amount of noise is small, the flare determination unit 47 determines whether there is no generation of flare (S-44). The AF pixel interpolation unit 45 executes one of the processings of the second pixel interpolation processing (S-45) when the flare determination unit 47 determines that the flare is not generated, and the third pixel interpolation processing (S-46) when it is determined that the flare is generated.

[Determination Whether −24 log₂ P−24 log₂ (Q/3.125)≦Th6 is Satisfied]

When the temperature of the imaging element 17 becomes T4 or more, the noise determination unit 46 determines whether or not the transmitted ISO sensitivity Q and shutter speed P satisfy [mathematical expression 48] (S-49).

−24 log₂P−24 log₂(Q/3.125)≦Th6 [Mathematical expression 48]

Note that Th6 is a threshold value (Th6>Th5). When the above-described expression is satisfied, it is determined that the amount of noise is large, and when the expression is not satisfied, it is determined that the amount of noise is small.

For example, when the noise determination unit 46 determines that the amount of noise is large, the AF pixel interpolation unit 45 executes the first pixel interpolation processing (S-43). On the other hand, when the noise determination unit 46 determines that the amount of noise is small, the flare determination unit 47 determines whether there is no generation of flare (S-44). The AF pixel interpolation unit 45 executes one of the processings of the second pixel interpolation processing (S-45) when the flare determination unit 47 determines that the flare is not generated, and the third pixel interpolation processing (S-46) when it is determined that the flare is generated.

As described above, by determining whether or not the conditional expression is satisfied, namely, by performing classification based on the temperature of the imaging element 17, and by determining whether the conditional expression is satisfied by using the ISO sensitivity and the shutter speed, the content of the pixel interpolation processing can be selected. Specifically, it is possible to achieve, without referring to the noise determination table, an effect similar to that of the noise determination using the noise determination table.

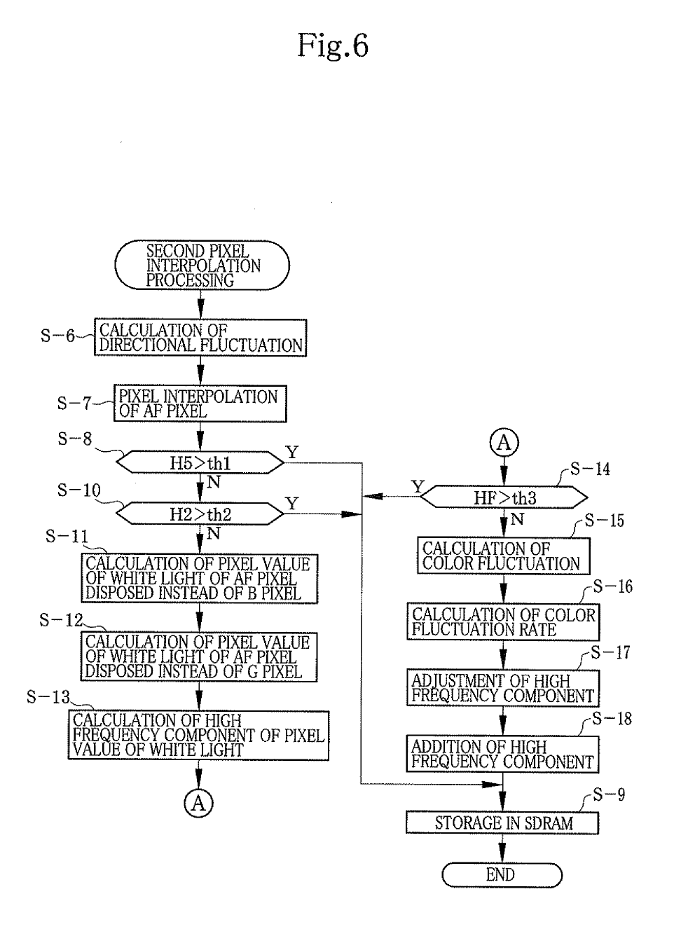

Note that the present embodiment describes the electronic camera, but, it need not be limited thereto, and it is also possible to make an image processing apparatus that captures an image obtained by the electronic camera and performs image processing, execute the processing in the flow charts of FIG. 5, FIG. 6 and FIG. 8. Further, in addition to this, it is also possible to apply the present invention to a program for realizing, with a computer, the processing in the flow charts of FIG. 5, FIG. 6 and FIG. 8. Note that the program is preferably stored in a computer-readable storage medium such as a memory card, an optical disk, and a magnetic disk.

The many features and advantages of the embodiment are apparent from the detailed specification and, thus, it is intended by the appended claims to cover all such features and advantages of the embodiment that fall within the true spirit and scope thereof. Further, since numerous modifications and changes will readily occur to those skilled in the art, it is not desired to limit the inventive embodiment to the exact construction and operation illustrated and described, and accordingly all suitable modifications and equivalents may be restored to, falling within the scope thereof.

What is claimed is:

1. An image pickup apparatus, comprising:
an imaging element having imaging pixels and focus detecting pixels;
a determining unit determining an amount of noise superimposed on an image obtained by driving the imaging element; and
a pixel interpolation unit executing the interpolation processing from among a plurality of interpolation processings with different processing contents in accordance with a determination result of the amount of noise determined by the determining unit, with respect to the image, to generate interpolation pixel values with respect to the focus detecting pixels.

2. The image pickup apparatus according to claim 1, wherein the determining unit determines the amount of noise superimposed on the image by using a photographic sensitivity at a time of performing photographing and a charge storage time in the imaging element.

3. The image pickup apparatus according to claim 2, further comprising
a temperature detection unit detecting a temperature of one of the imaging element and a control board provided in the image pickup apparatus, wherein
the determining unit determines the amount of noise superimposed on the image by using the temperature of one of the imaging element and the control board, in addition to the photographic sensitivity at the time of performing photographing and the charge storage time in the imaging element.

4. The image pickup apparatus according to claim 1, wherein
the pixel interpolation unit executes the interpolation processing using pixel values of the imaging pixels positioned in a neighborhood of the focus detecting pixels, to generate the interpolation pixel values with respect to the focus detecting pixels when the determining unit determines that the amount of noise superimposed on the image is large.

5. The image pickup apparatus according to claim 1, wherein
the pixel interpolation unit executes the interpolation processing using pixel values of the focus detecting pixels and the imaging pixels positioned in the neighborhood of the focus detecting pixels, to generate the interpolation pixel values with respect to the focus detecting pixels when the determining unit determines that the amount of noise superimposed on the image is small.

6. The image pickup apparatus according to claim 1, further comprising
a shutter moving between an open position in which a subject light is irradiated to the imaging element and a light-shielding position in which the subject light is shielded, wherein:
the image is formed of a first image obtained when the shutter is held at the open position by the charge storage time, and a second image obtained when the shutter is held at the light-shielding position by the charge storage time; and
the image interpolation unit executes the interpolation processing based on an estimation result of the amount of noise with respect to the first image and the second image.

7. The image pickup apparatus according to claim 6, further comprising
an image processing unit subtracting each pixel value of the second image from each pixel value of the first image after performing the interpolation processing on the images by the pixel interpolation unit.

8. An image processing apparatus, comprising:
an image capturing unit capturing an image obtained by using an imaging element having imaging pixels and focus detecting pixels;
a determining unit determining an amount of noise superimposed on the image; and
a pixel interpolation unit executing the interpolation processing from among a plurality of interpolation processings with different processing contents in accordance with a determination result of the amount of noise determined by the determining unit, with respect to the image, to generate interpolation pixel values with respect to the focus detecting pixels.

9. A non-transitory computer readable storage medium storing an image processing program causing a computer to execute:
an image capturing process of capturing an image obtained by using an imaging element having imaging pixels and focus detecting pixels;
a determining process of determining an amount of noise superimposed on the image; and
a pixel interpolation process of executing the interpolation processing from among a plurality of interpolation processings with different processing contents in accordance with a determination result of the amount of noise determined by the determining process, with respect to the image, to generate interpolation pixel values with respect to the focus detecting pixels.
